(19) United States
(12) Patent Application Publication
(10) Pub. No.: US 2016/0161894 A1
(43) Pub. Date: Jun. 9, 2016

(54) IMAGE FORMING APPARATUS

(71) Applicant: Shohei SHINKAWA, Tokyo (JP)

(72) Inventor: Shohei SHINKAWA, Tokyo (JP)

(73) Assignee: Ricoh Company, Ltd., Tokyo (JP)

(21) Appl. No.: 14/955,097

(22) Filed: Dec. 1, 2015

(30) Foreign Application Priority Data
Dec. 3, 2014 (JP) 2014-245326

(51) Int. Cl. G03G 15/00; B65H 1/04; B65H 9/14; B65H 9/00

(52) U.S. Cl. CPC G03G 15/6567; B65H 9/002; B65H 1/04; B65H 9/14

(57) ABSTRACT

An image forming apparatus includes a body; an image forming unit to form an image on a sheet of recording medium; a sheet feed device including a correction roller to adjust a timing and posture of the sheet conveyed to the image forming unit, wherein the sheet feed device is disposed with a mounting angle thereof adjustable within a conveyance plane of the sheet; a process unit disposed upstream or downstream of the sheet feed device in a sheet conveyance direction; and a guide disposed between the sheet feed device and the process unit, to fill a gap between the sheet feed device and the process unit to guide the conveyed sheet. The guide is disposed with a mounting angle thereof adjustable to the mounting angle of the sheet feed device within the conveyance plane.

### CROSS-REFERENCE TO RELATED APPLICATION

The present application claims priority pursuant to 35 U.S.C. §119(a) from Japanese patent application number 2014-245326, filed on Dec. 3, 2014, the entire disclosure of which is incorporated by reference herein.

### BACKGROUND

1. Technical Field

The present invention relates to an image forming apparatus.

2. Background Art

Image forming apparatuses employing electrophotography forma toner image with an image forming unit and the image thus formed is then transferred onto a sheet of paper or the like (herein, simply a sheet).

More specifically, in such an image forming apparatus, the toner image formed by the image forming unit is once transferred to a transfer device, and the thus-transferred image is then further transferred to the sheet. The above-described image forming apparatus may include a correction roller or a registration roller to correct a skew of the sheet relative to the transfer device, and send the sheet onward with a predetermined timing. The correction roller is configured to have an angle adjustable relative to the transfer device.

### SUMMARY

In one embodiment of the disclosure, provided is an optimal image forming apparatus including a body; an image forming unit to form an image on a sheet of recording medium; a sheet feed device including a correction roller to adjust a timing and posture of the sheet conveyed to the image forming unit, wherein the sheet feed device is disposed with a mounting angle thereof adjustable within a conveyance plane of the sheet; a process unit disposed upstream or downstream of the sheet feed device in a sheet conveyance direction; and a guide disposed between the sheet feed device and the process unit, to fill a gap between the sheet feed device and the process unit to guide the conveyed sheet. The guide is disposed with a mounting angle thereof adjustable to the mounting angle of the sheet feed device within the conveyance plane.

These and other objects, features, and advantages of the present invention will become apparent upon consideration of the following description of the preferred embodiments of the present invention when taken in conjunction with the accompanying drawings.

### BRIEF DESCRIPTION OF THE DRAWINGS

FIG. 1 illustrates a schematic view of an image forming apparatus, to which an embodiment of the present invention is applied;

FIGS. 2A and 2B each illustrate a sheet feed device of the image forming apparatus according to a first embodiment: FIG. 2A is a view taken along B-B line of FIG. 2B, and FIG. 2B illustrates a view taken along A-A line of FIG. 2A;

FIGS. 3A and 3B each illustrate a sheet feed device of the image forming apparatus according to a second embodiment: FIG. 3A a view taken along B-B line of FIG. 3B, and FIG. 3B illustrates a view taken along A-A line of FIG. 3A;

FIG. 4 is a block diagram illustrating a controller or a controlling system applied to the second embodiment of the present invention; and

FIGS. 5A and 5B each illustrate a sheet position adjuster of a conventional image forming apparatus: FIG. 5A is a view taken along B-B line of FIG. 5B, and FIG. 5B illustrates a view taken along A-A line of FIG. 5A.

### DETAILED DESCRIPTION

In the typical image forming apparatus as described in the above background section, a guide plate for the sheet disposed around the correction roller does not follow the correction roller when the guide plate corrects the position of the correction roller. As a result, the sheet is skewed in a gap formed before the correction roller. In addition, a contact pressure of Mylar (registered trademark), contacting the correction roller, that collects paper dust, weakens and its effectiveness deteriorates.

Accordingly, typically instead of just the correction roller itself a sheet adjusting unit including the correction roller and the guide plate disposed around the correction roller are formed as a single integrated unit, and the angle of the sheet correction device is adjusted. However, when the angle of the sheet adjuster and the posture of the correction roller are adjusted, a gap between the sheet correction device and an upstream or downstream process unit widens and the sheet cannot be fed properly. Thus, there is a limit to the adjustment angle of the sheet correction device.

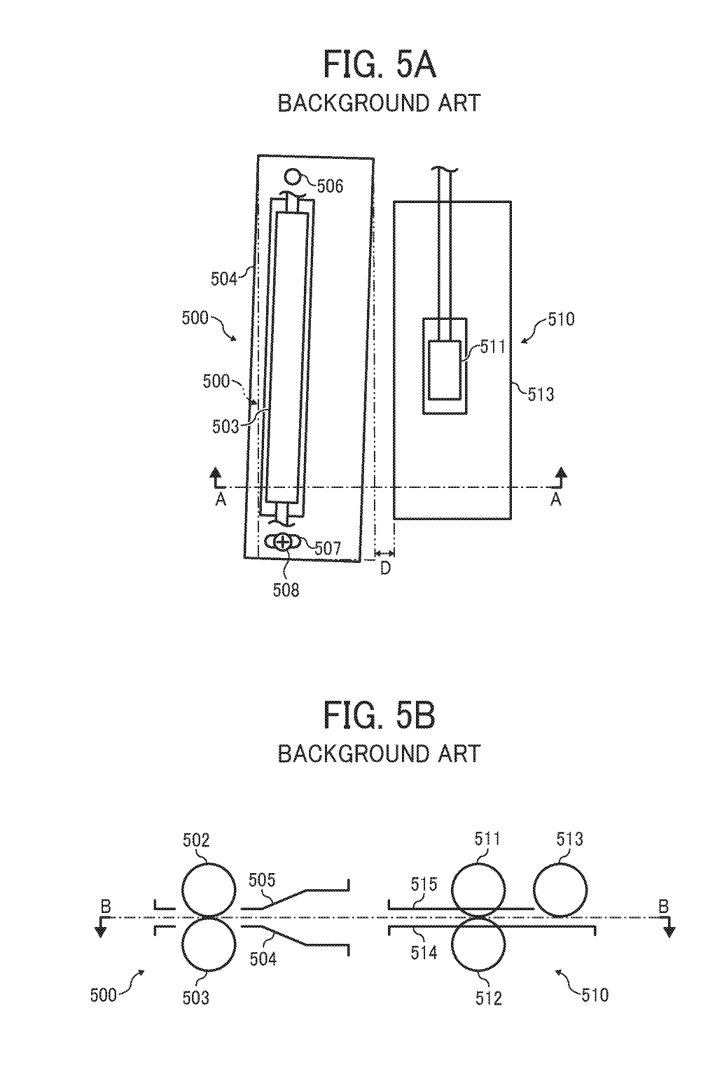

FIGS. 5A and 5B schematically illustrate a sheet feed device and its peripheral portion. In this example, a sheet feed device 500 as a sheet adjuster and a sheet supply device 510 to supply a sheet to the sheet feed device 500 are disposed. A transfer roller to transfer a toner image onto a sheet is disposed downstream in the sheet feed direction of the sheet feed device 500.

The sheet feed device 500 includes a correction roller 502, a driven roller 503, a lower guide plate 504, and an upper guide plate 505. As illustrated in FIG. 5A, the sheet feed device 500 includes a shaft 506 serving as a rotary center and disposed in the back, and a slot 507 for mounting, formed perpendicular to the axis of the shaft and disposed in the front side. With this structure, when the fixing member 508 is fixed to the slot 507 for mounting, an angle of the sheet feed device 500 can be adjusted by pivoting about the shaft 506, so that an angle of the correction roller 502 relative to the transfer roller may be adjusted. The adjustment of the angle is usually performed during manufacture of the image forming apparatus; however, the adjustment of the angle can be implemented after assembly of the apparatus or during operation of the apparatus, if a driving unit such as a motor is used for adjustment of the position,

The sheet supply device 510 includes a feed roller 511, a backup roller 512, a pickup roller 513, a lower guide plate 514, and an upper guide plate 515. The lower and upper guide plates 514 and 515 are for feeding sheet. A predetermined gap should exist between the lower guide plate 504 and the upper guide plate 505 of the sheet feed device 500, and the lower guide plate 514 and the upper guide plate 515 of the sheet supply device 510, considering that the sheet feed device 500 is tilted relative to the sheet supply device 510. As a result, a gap D before adjustment of the angle of the sheet feed device 500 cannot be narrowed. FIG. 5A represents a state in which a bottom side in the figure of the sheet feed device 500 is tilted toward the transfer roller. In this state, the gap between the lower guide plate 504 and the upper guide plate 505 in the front side of the sheet feed device 500, and the lower guide plate 514 and the upper guide plate 515 of the sheet supply device 510 further increases. As a result, when a curled sheet is conveyed, the sheet is separated from a portion between the lower guide plate 504 and the upper guide plate 505. Accordingly, there is a limit to the adjustment amount of the sheet feed device 500.

In addition, in the above structure, because the positioning is performed via the guide member, a gap of a guide plate receiving portion widens. Specifically, the gap between the lower guide plate 504 and the upper guide plate 505 of the sheet feed device 500, and the lower guide plate 514 and the upper guide plate 515 of the sheet supply device 510, widens. Further, due to limitation of either side of upstream and downstream, the gap widens in the not-positioned side. As a result, when the angle is adjusted by the sheet feed device, the gap of the receiving portion with the upstream or downstream guide plate widens and the sheet cannot be fed properly, so that the adjustment angle is limited.

Accordingly, as described below, according to at least one embodiment of the present invention, an image forming apparatus can prevent the sheet from separating from the sheet feed device in the upstream or downstream of the sheet feed device, even though the angle of the sheet feed device is adjusted roughly.

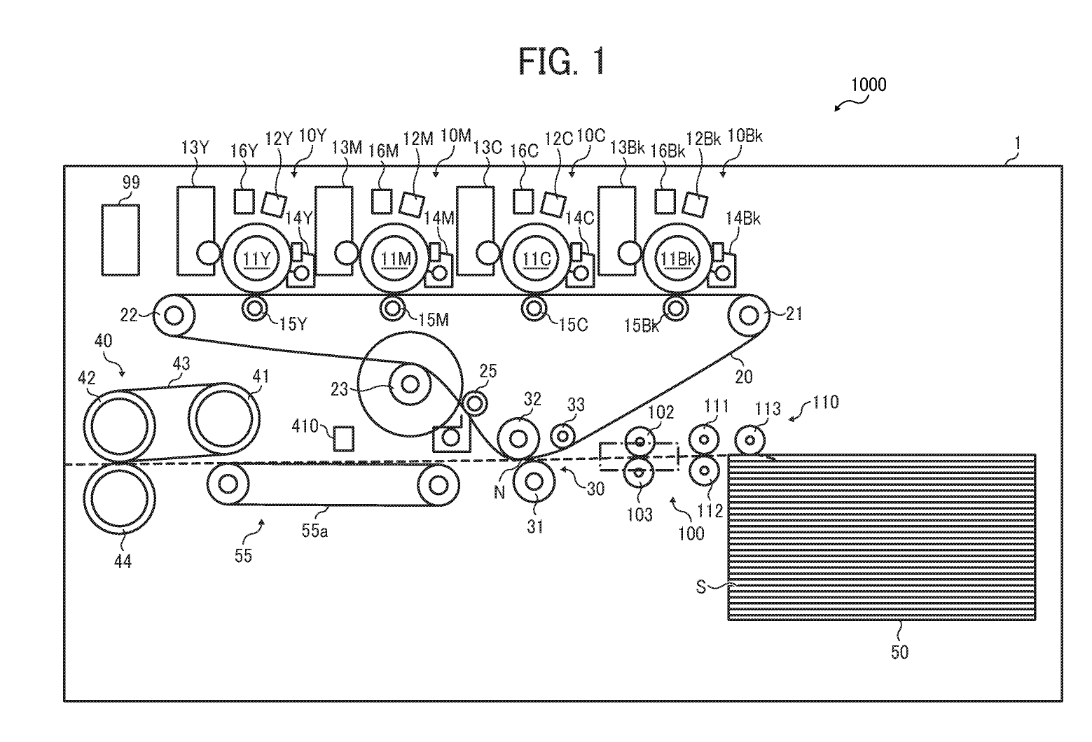

FIG. 1 illustrates a schematic view of the image forming apparatus 1000, to which the embodiment of the present invention will be described, is a tandem-type color image forming apparatus capable of forming a full-color image.

The image forming apparatus 1000 forms a color image by superimposing four color toner images of yellow (Y), magenta (M), cyan (C), and black (Bk). The image forming apparatus 1000 includes four image forming units 10Y, 10M, 10C, and 10Bk, and an intermediate transfer belt 20. A color toner image of each color is primarily transferred from the image forming units 10Y, 10M, 10C, and 10Bk to the intermediate transfer belt 20, so that a full-color toner image is formed on a sheet S. The intermediate transfer belt 20 is an endless belt stretched around a plurality of rollers 21, 22, 23, 25, 32, and 33. In addition, the image forming units 10Y, 10M, 10C, and 10Bk are sequentially disposed along an upper surface of the intermediate transfer belt 20. The roller 21 serves as a drive roller among the plurality of rollers 21, 22, 23, 25, 32, and 33.

Each of the image forming units 10Y, 10M, 10C, and 10Bk handles different color of toner but is configured identical to each other. Each of the image forming units 10Y, 10M, 10C, and 10Bk includes a photoconductor drum 11 serving as an image bearer, a charger 12, a developing device 13, a cleaner 14, and a primary transfer roller 15, respectively. The charger 12, the developing device 13, the cleaner 14, and the primary transfer roller 15 are disposed around each photoconductor drum 11. Herein, suffixes of Y, M, C, and Bk are omitted because each image forming unit 10Y, 10M, 10C, or 10Bk is similarly configured. The primary transfer roller 15 is so disposed in an interior of the intermediate transfer belt 20 as to oppose to the photoconductor drum 11, to thereby form a primary transfer section.

In addition, each image forming unit 10Y, 10M, 10C, or 10Bk in the image forming apparatus 1000 according to the present embodiment includes an exposure device 16. The exposure device 16 employs a light emitting diode (LED), for example, disposed between the charger 12 and the developing device 13. Alternatively, the exposure device 16 may employ a laser writer, for example, which is common to each image forming unit 10. Further, the present image forming apparatus 1000 includes a secondary transfer roller 31, serving as a secondary transfer device and disposed opposite a transfer opposite roller 32, via the intermediate transfer belt 20. In the present embodiment, the intermediate transfer belt 20 and the secondary transfer roller 31 contacts each other to form a transfer nip N, that is, a secondary transfer unit 30.

A sheet feed device 100 that prevents a skew of the sheet S, a recording medium, is disposed upstream of the secondary transfer roller 31. The sheet feed device 100 includes a correction roller 102 and a driven roller 103, to thereby adjust timing of the sheet S to be fed to the secondary transfer unit 30 while correcting a feeding posture and a skew of the sheet S. Another feed device 55 including an endless belt 55a is disposed on the left in FIG. 1 of the secondary transfer roller 31. In addition, a fixing device 40 is disposed on the left in FIG. 1 of the feed device 55. The fixing device 40 is a belt fixing device including a fixing belt 43 stretched around a heat roller 41 and a fixing roller 42, and a pressure roller 44 is pressed against the fixing roller 42 with the fixing belt 43 sandwiched in between.

A sheet supply device 110, another process unit, is disposed upstream of the sheet feed device 100. The sheet supply device 110 includes a paper tray 50 to stack a bundle of sheets, a feed roller 111, a backup roller 112, and a pickup roller 113. The secondary transfer unit 30 that serves as another process unit, is disposed downstream of the sheet feed device 100. Otherwise, a manual sheet feeder or a sheet reversing unit can be disposed if needed. In addition, an image reader or a scanner, and an automatic document feeder (ADF) can be disposed appropriately.

Next, image forming operation performed in the image forming apparatus 1000 will be described. Each of the image forming units 10Y, 10M, 10C, and 10Bk performs image forming operation in the similar manner. Each photoconductor drum 11 for each of the image forming units 10Y, 10M, 10C, and 10Bk is rotated in the counterclockwise direction by a drive unit, and the charger 12 uniformly charges each surface of the photoconductor drum 11 at a predetermined polarity. The exposure device 16 irradiates scanning light to the charged surface of the photoconductor drum 11, so that an electrostatic latent image is formed on the surface of the photoconductor drum 11 of each of the image forming units 10Y, 10M, 10C, and 10Bk.

In this case, the image data exposed on each photoconductor drum 11 is monochrome image data decomposed, from the target full-color image, into color data of yellow, magenta, cyan, and black. Each developing device 13 supplies toner of each color to the electrostatic latent image formed on the surface of the photoconductor drum 11, and the electrostatic latent image is rendered visible as a toner image. In addition, the intermediate transfer belt 20 is rotated in the clockwise direction in FIG. 1, each color toner image on each of the photoconductor drums 11Y, 11M, 11C, and 11Bk is sequentially transferred to the intermediate transfer belt 20 in a superimposed manner due to effect of the primary transfer roller 15 in each image forming unit 10.

With the operation above, a full-color toner image is formed and retained on the surface of the intermediate transfer belt 20. It is noted that a monochrome image can be formed using any one of the image forming units 10, and any plural number of image forming units 10 are used and a two-color image or three-color image may be formed. In the case of monochrome print, the rightmost image forming unit 10Bk for a color of black is used, among four image forming units, to form an image.

The residual toner adhering to the surface of the photoconductor drum 11 after toner image transfer, is removed by the cleaner 14 from the surface of the photoconductor drum 11, and the surface potential on its surface is initialized by an effect of the discharger, to thereby be ready for the next image formation. On the other hand, the sheet S is conveyed from the paper tray 50, the skew is corrected by the sheet feed device 100, and the sheet S is fed out to a secondary transfer position timed with the toner image retained on the intermediate transfer belt 20.

The toner image formed on the intermediate transfer belt 20 by the secondary transfer roller 31 is transferred en bloc to the sheet S at the transfer nip N. The sheet S on which the toner image is transferred is conveyed by the feed device 55 to the fixing device 40, and the toner image is fused and fixed onto the sheet S with heat and pressure. The sheet S onto which the toner image is fixed, is discharged to a sheet ejection tray.

### First Embodiment

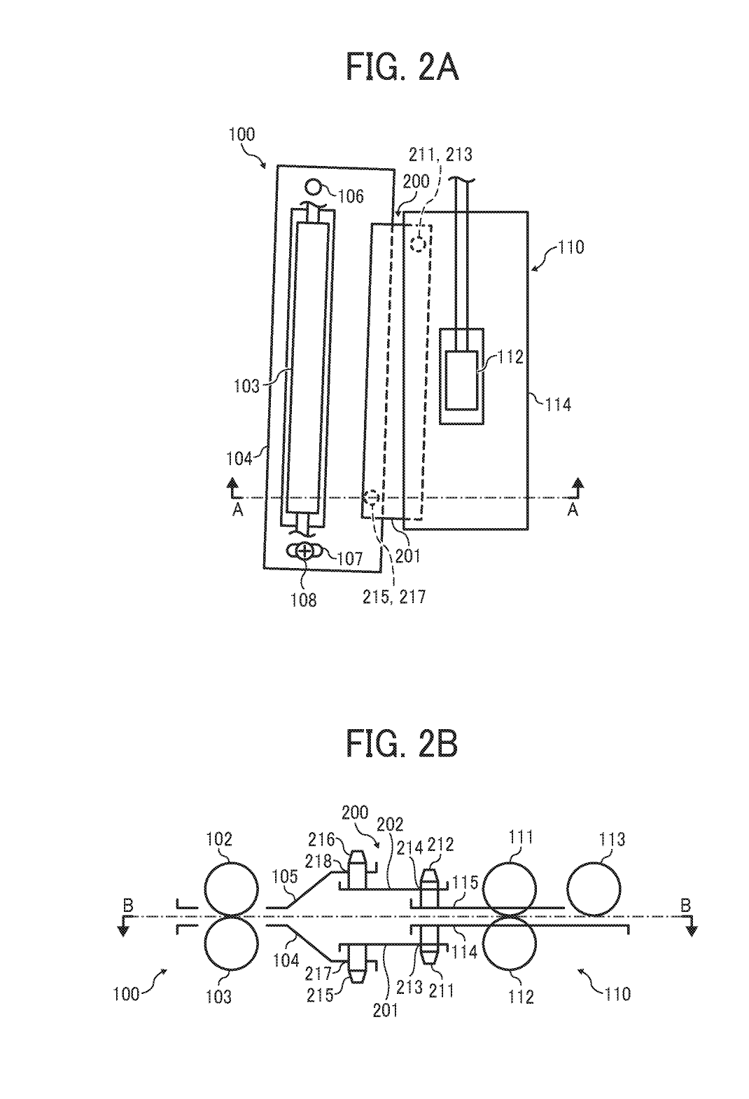

Next, a structure around the sheet feed device 100 of the image forming apparatus according to a first embodiment of the present invention will be described with reference to FIGS. 2A and 2B. FIG. 2A illustrates a view taken along B-B line of FIG. 2B and FIG. 2B illustrates a view taken along A-A line of FIG. 2A.

A sheet supply device 110 is disposed upstream in the sheet feed direction of the sheet feed device 100. The sheet feed device 100 includes a correction roller 102 to abut the sheet S to correct a skew of the sheet S, a driven roller 103 driven to rotate following the correction roller 102, a lower guide plate 104, and an upper guide plate 105, both relating to correct the skew of the sheet. As illustrated in FIG. 2A, a mounting angle of the sheet feed device 100 can be changed by a shaft 106 within a sheet conveyance plane defined by the sheet. In addition, the lower guide plate 104 of the sheet feed device 100 has a slot 107 formed therein for mounting as illustrated in the bottom of FIG. 2A. The lower guide plate 104 is mounted to the sheet feed device 100 with the mounting angle adjustable by a fixing member 108. In the present embodiment, the fixing member is a screw.

The sheet supply device 110 includes a feed roller 111, a backup roller 112, a pickup roller 113, a lower guide plate 114, and an upper guide plate 115. The lower and upper guide plates 114 and 115 are for feeding sheet.

A guide member 200 is so disposed, between the sheet feed device 100 and the sheet supply device 110, to fill a gap between the sheet feed device 100 and the sheet supply device 110. The guide member 200 includes a lower guide plate 201 and an upper guide plate 202, so that the sheet S is guided via a portion between the upper and lower guides, to thereby prevent the sheet S from separating from the portion in between. The lower guide plate 201 and the upper guide plate 202 each are formed of a plate-like member.

As illustrated in FIG. 2A, holes 213 and 214 are formed on the upper end side of each of the lower guide plate 201 and the upper guide plate 202. Shafts 211 and 212 that vertically protrude from the lower guide plate 114 and the upper guide plate 115 of the sheet supply device 110, engage the holes 213 and 214. With this structure, the lower guide plate 201 and the upper guide plate 202 are supported by the lower guide plate 114 and the upper guide plate 115 of the sheet supply device 110 with the disposed angle thereof changeable.

As illustrated in FIG. 2A, shafts 215 and 216 are so disposed as to protrude from an edge of the lower guide plate 201 and the upper guide plate 202. The shafts 211 and 212 engage holes 217 and 218 of the lower guide plate 114 and the upper guide plate 115, respectively. With this structure, the lower guide plate 201 and the upper guide plate 202 rotate with the sheet feed device 100.

The shafts 211 and 212 and the shafts 215 and 216 preferably protrude in a counter direction to the sheet feed surface so as not to prevent sheet feeding.

According to the present embodiment, even though the angle of the sheet feed device 100 is adjusted, the lower guide plate 201 and the upper guide plate 202 of the guide member 200 move following the movement of the sheet feed device 100. As a result, the gap between the sheet feed device 100 and the sheet supply device 110 into which the sheet S enters is filled depending on the adjusted angle of the sheet feed device 100. As a result, even though the curled sheet S is fed, the sheet S does not separate from the gap. Thus, the sheet feed device 100 can be roughly adjusted.

### Second Embodiment

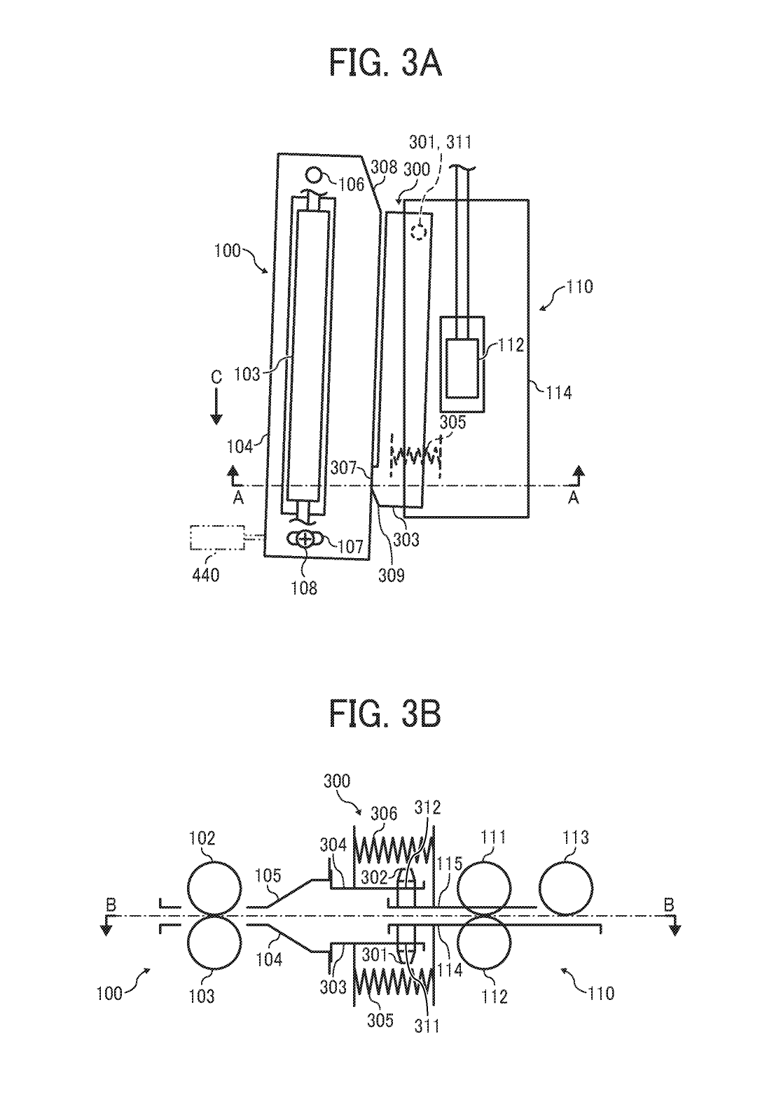

Next, the image forming apparatus according to a second embodiment will be described. The basic structures of the image forming apparatus 1000 are similar to those according to the first embodiment. FIGS. 3A and 3B each illustrate a sheet feed device of the image forming apparatus according to the second embodiment. FIG. 3A illustrates a view taken along B-B line of FIG. 3B and FIG. 3B illustrates a view taken along A-A line of FIG. 3A.

The basic structures of the sheet feed device 100 and the guide member 200 according to the second embodiment are similar to those in the first embodiment. In the second embodiment, a guide member 300 is disposed between the sheet feed device 100 and the guide member 200.

The sheet feed device 100 includes a correction roller 102, a driven roller 103, a lower guide plate 104, and an upper guide plate 105. In addition, the sheet feed device 100 pivots about a shaft 106 to adjust an angle and is fixed at a predetermined angle with a slot 107 for mounting and a fixing member 108 such as a screw.

The sheet supply device 110 includes a feed roller 111, a backup roller 112, a pickup roller 113, a lower guide plate 114, and an upper guide plate 115. As illustrated in FIG. 3A, shafts 301 and 302 to retain the guide member 300 rotatably are disposed on the lower guide plate 114 and the upper guide plate 115 of the sheet supply side.

In the present embodiment, the guide member 300 includes a lower guide plate 303 and an upper guide plate 304, in which a hole 311 and a hole 312 are created, respectively. The shafts 301 and 302 can be inserted to the holes 311 and 312, respectively. With this structure, the guide member 300 can pivot about the shafts 301 and 302.

Further, the sheet feed device 100 includes springs 305 and 306, each serving as a biasing member to press the guide member 300 against the sheet feed device 100. With this structure, the lower guide plate 303 and the upper guide plate 304 are constantly pressed against the sheet feed device 100 by the springs 305 and 306. The lower guide plate 303 and the upper guide plate 304 include a bottom end 307, and are positioned by abutting the bottom end 307 against the sheet feed device 100.

According to the present embodiment, even though the angle of the sheet feed device 100 is adjusted, because the lower guide plate 303 and the upper guide plate 304 move following the movement of the sheet feed device 100, a gap between the sheet feed device 100 and the sheet supply device 110 does not change due to adjustment of the angle. As a result, even the curled sheet does not separate from the guides, and the sheet feed device 100 can be roughly adjusted.

In addition, because the sheet feed device 100 and the sheet supply device 110 move independently, the both can be assembled without difficulty. Further, the lower guide plate 303 and the upper guide plate 304 are not fixed to the sheet feed device 100. As a result, the sheet feed device 100 and the image forming units can be pulled out from the body 1 of the image forming apparatus 1000 in a direction of arrow C as indicated in FIG. 3A. As a result, when a jammed paper is removed together with the pulled out device, the removal of the sheet may be performed similarly effectively.

After the removal of the jammed sheet, when the sheet feed device is inserted to the apparatus body 1 in a counter direction of the direction C, the lower guide plate 303 and the upper guide plate 304 may disturb the insertion. Accordingly, a slant 308 and another slant 309 may preferably be disposed at portions to which the sheet feed device first contacts.

### Third Embodiment

Next, the image forming apparatus according to a third embodiment will be described.

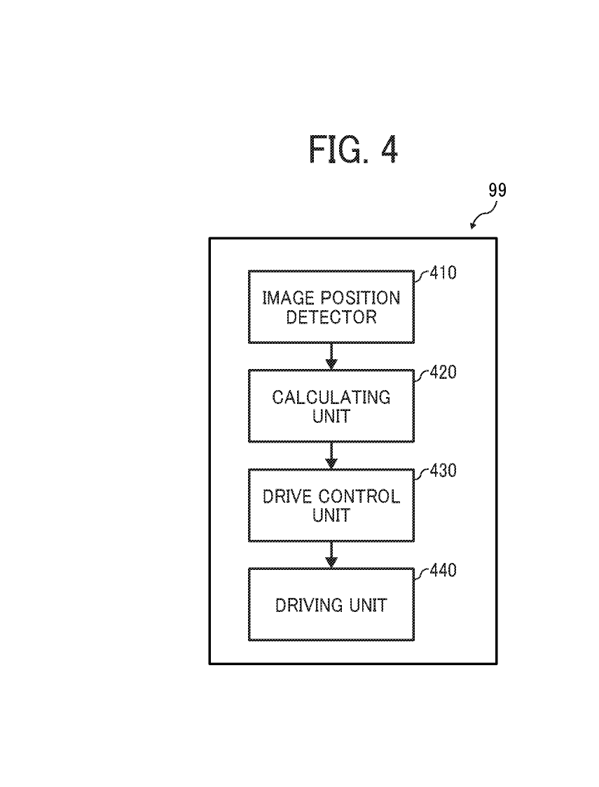

The image forming apparatus according to the third embodiment is configured to automatically change an angle of the sheet feed device 100 by identifying a formed image. FIG. 4 is a block diagram illustrating a controller 99 or a controlling system applied to the sheet feed device 100 of the image forming apparatus 1000 according to the second embodiment of the present invention. The sheet feed device 100 includes a driving unit 440 (see FIGS. 3 and 4) that serves to change a mounting angle of the sheet feed device 100. In addition, the guide member 200 according to the first embodiment or the guide member 300 according to the second embodiment is disposed.

The driving unit 440 is a known linear motion device driven by a motor, an electromagnetic solenoid, or the like. The driving unit 440 is driven by a drive control unit 430.

In each of the above embodiments, as illustrated in FIG. 1, an image position detector 410 is disposed. The status of the image including a skew and distortion of the image is calculated based on the image position data detected by the image position detector 410. Calculation is performed by a calculating unit 420, and the calculation result is output to the drive control unit 430.

The drive control unit 430 calculates an adjustment amount of the necessary angle based on the calculation results and drives the driving unit 440. The image position detector 410 continues the above process until no abnormality is recognized. According to the present embodiment, an angle of the sheet feed device 100 is adjusted based on the data concerning the skew and distortion of the image, so that parallelism can be adjusted optimally. As a result, regardless of the type or the size of the sheet, the sheet S can be fed without stress.

In the above embodiment, the guide member is disposed upstream in the sheet feed direction of the sheet feed device 100; alternatively, the guide member can be disposed between a process unit such as a transfer device disposed downstream, and the sheet feed device 100. The guide member can also be disposed both in the upstream and the downstream of the sheet feed device 100.

Additional modifications and variations of the present invention are possible in light of the above teachings. It is therefore to be understood that, within the scope of the appended claims, the invention may be practiced other than as specifically described herein.

What is claimed is:

1. An image forming apparatus comprising:
a body;
an image forming unit to form an image on a sheet of recording medium;
a sheet feed device including a correction roller to adjust a timing and posture of the sheet conveyed to the image forming unit, wherein the sheet feed device is disposed with a mounting angle thereof adjustable within a conveyance plane of the sheet;
a process unit disposed upstream or downstream of the sheet feed device in a sheet conveyance direction; and
a guide disposed between the sheet feed device and the process unit, to fill a gap between the sheet feed device and the process unit to guide the conveyed sheet,
wherein the guide is disposed with a mounting angle thereof adjustable to the mounting angle of the sheet feed device within the conveyance plane.

2. The image forming apparatus as claimed in claim 1, wherein the guide is rotatably supported by the sheet feed device with the mounting angle of the guide adjustable in accordance with an angle of the sheet feed device.

3. The image forming apparatus as claimed in claim 1, further comprising a biasing member to press the guide against the sheet feed device,
wherein at least a part of the guide abuts the sheet feed device to adjust the mounting angle of the guide.

4. The image forming apparatus as claimed in claim 1, wherein one end of the guide is rotatably supported by the sheet feed device.

5. The image forming apparatus as claimed in claim 3, wherein one end of the guide is rotatably supported by the sheet feed device.

6. The image forming apparatus as claimed in claim 1, wherein the sheet feed device comprises guide plates to guide the sheet to be fed, and at least one end of the guide plates of the sheet feed device and the guide includes a slanted portion inclined relative to a direction of attachment or detachment of the sheet feed device to or from the body of the image forming apparatus.

7. The image forming apparatus as claimed in claim 1, wherein the process unit disposed upstream of the sheet feed device is a sheet supply device.

8. The image forming apparatus as claimed in claim 1, further comprising:
a driving unit to move the sheet feed device to adjust a mounting angle of the sheet feed device relative to the image forming unit;
an image position detector to detect a position of an image formed by the image forming unit;
a calculating unit to calculate a status of the image including a skew and distortion of the image based on image position data detected by the image position detector; and
a drive control unit to drive the driving unit by an adjustment amount based on a calculation result obtained by the calculating unit to adjust the mounting angle of the sheet feed device to eliminate the skew and distortion of the image.
